(19) United States
(12) Patent Application Publication
(10) Pub. No.: US 2011/0119662 A1
(43) Pub. Date: May 19, 2011

(54) METHOD FOR UPDATING FIRMWARE OF EMBEDDED SYSTEM

(75) Inventors: Chih-Wei CHEN, TAIPEI CITY (TW); Hsiao-Fen LU, TAIPEI CITY (TW)

(73) Assignee: INVENTEC CORPORATION, TAIPEI CITY (TW)

(21) Appl. No.: 12/648,288

(22) Filed: Dec. 28, 2009

(30) Foreign Application Priority Data
Nov. 18, 2009 (TW) 98139186

(51) Int. Cl. G06F 9/44; G06F 11/10

(52) U.S. Cl. 717/168; 714/48; 714/E11.04

(57) ABSTRACT

A method for updating firmware of an embedded system includes the following steps: a firmware update instruction for updating the firmware of the embedded system according to a firmware image is received. Wherein, the embedded system includes a memory and a storage unit. The firmware of the embedded system is stored in the storage unit. The firmware image is divided into several partition images. Several available blocks are obtained from the memory. The partition images are stored into the available blocks. Information of the partition images stored in the available blocks is recorded into an image information table. The partition images are obtained from the memory according to the image information table. The firmware of the embedded system is overwritten by the partition images obtained.

### RELATED APPLICATIONS

This application claims priority to Taiwan Application Serial Number 98139186, filed Nov. 18, 2009, which is herein incorporated by reference.

### BACKGROUND

1. Field of Invention

The present invention relates to a method for updating firmware, and more particularly to a method for updating firmware of an embedded system.

2. Description of Related Art

An embedded system is a dedicated computer system designed to fit specific application requirements, and includes all kinds of computers except a general-purpose personal computers (PC). Embedded systems can be found on devices that include a mobile music player to an in situ control subsystem of a space shuttle. The embedded system only can be used to achieve the task for some specific purposes and is different from the general PC system which can be used to satisfy various tasks. Furthermore, the embedded system also has to satisfy some basic performances, such as security and availability. Besides, other functions may require a fewer or nothing to simplify the hardware of the embedded system, and thereby the cost can be reduced. For mass-produced embedded systems, the cost reduction is usually the primary consideration when the embedded system is under design. Therefore, the embedded system usually needs to be simplified to remove unnecessary functions, thereby lowering cost.

The core of the embedded systems is formed by one or more microprocessors or microcontrollers which are pre-programmed to execute few tasks. Compared to a general PC which can execute various software installed by a user, the software installed in the embedded system is usually temporarily unchanged, so that it is called as firmware.

After the embedded system is operated for a period of time, much information will occupy the memory space of the embedded system, and thus the available continuous memory space decreases. Therefore, if the firmware of the embedded system is updated at this moment, the firmware update may fail to due to insufficient available continuous memory space.

### SUMMARY

Therefore, according to one aspect of the present invention, a method for updating firmware of an embedded system is provided for dividing an image (firmware image) for updating the firmware into several partitioned images; storing the partitioned images into a plurality of available blocks in a memory respectively; and updating the firmware with the respective partitioned images stored in the memory. The method for updating firmware of the embedded system includes the following steps. First, a firmware update instruction is received to update the firmware of the embedded system with the firmware image, wherein the embedded system includes a memory and a storage unit, and the firmware of the embedded system is stored in the storage unit. Then, the firmware image is divided into several partitioned images. A plurality of available blocks are obtained from the memory. The partitioned images are stored into the available blocks. Information of the partition images stored in the available blocks is recorded into an image information table. The partitioned images are obtained from the memory according to the image information table. The firmware of the embedded system stored in the storage unit is overwritten by the partitioned images obtained.

According to one embodiment of the present invention, the embedded system further includes a processing unit, and the method for updating firmware of the embedded system further includes reactivating the processing unit before overwriting the firmware of the embedded system the stored in the storage unit.

According to another embodiment of the present invention, the method for updating firmware of the embedded system further includes determining if the image information table exists. If the image information table exists, partitioned images are obtained from a memory according to the image information table. If the image information table does not exist, the embedded system is operated according to the firmware of the embedded system.

According to another embodiment of the present invention, the method for updating firmware of the embedded system further includes obtaining a split file size of each of the partitioned images, wherein the partitioned images have the same size.

According to another embodiment of the present invention, the step of dividing the firmware image into several partitioned images includes sequentially reading several data at the split file size from the firmware image as the partitioned images.

According to another embodiment of the present invention, the method for updating firmware of the embedded system further includes removing the image information table after the step overwriting the firmware of the embedded system stored in the storage unit by using the partitioned images obtained.

According to another embodiment of the present invention, the method for updating firmware of the embedded system further includes setting the storage unit to be accessible before the step of overwriting the firmware of the embedded system stored in the storage unit by using the partitioned images obtained.

According to another embodiment of the present invention, the method for updating firmware of the embedded system further includes setting the storage unit to be write protected after the step of overwriting the firmware of the embedded system stored in the storage unit by using the partitioned images obtained.

According to another embodiment of the present invention, the method for updating firmware of the embedded system further includes detecting if the partitioned images obtained have errors. When the obtained partitioned images have no errors, the step of overwriting the firmware of the embedded system stored in the storage unit by using the partitioned images obtained is achieved.

According to another embodiment of the present invention, the step of detecting if the partitioned images obtained have errors is achieved by using a checksum function.

The advantages of applying the embodiments of the present invention are as below. Even though the memory of the embedded system does not have enough continuous available space, the firmware of the embedded system still can be updated. Moreover, by reactivating the processing unit of the embedded system to release the system resource of the processing unit, that updating the firmware fails because the processing unit does not have enough system resource can be avoided. That is to say, even though the embedded system has been operated for a period of time, the embedded system still can update the firmware.

### BRIEF DESCRIPTION OF THE DRAWINGS

For the purpose that the aforementioned objects, features, advantages, and embodiments of the present invention can be more obviously and easily understood, the accompanying figures are explained as below:

FIG. 1 is a flow chart of a method for updating firmware of an embedded system according to one embodiment of the present invention.

### DESCRIPTION OF THE PREFERRED EMBODIMENTS

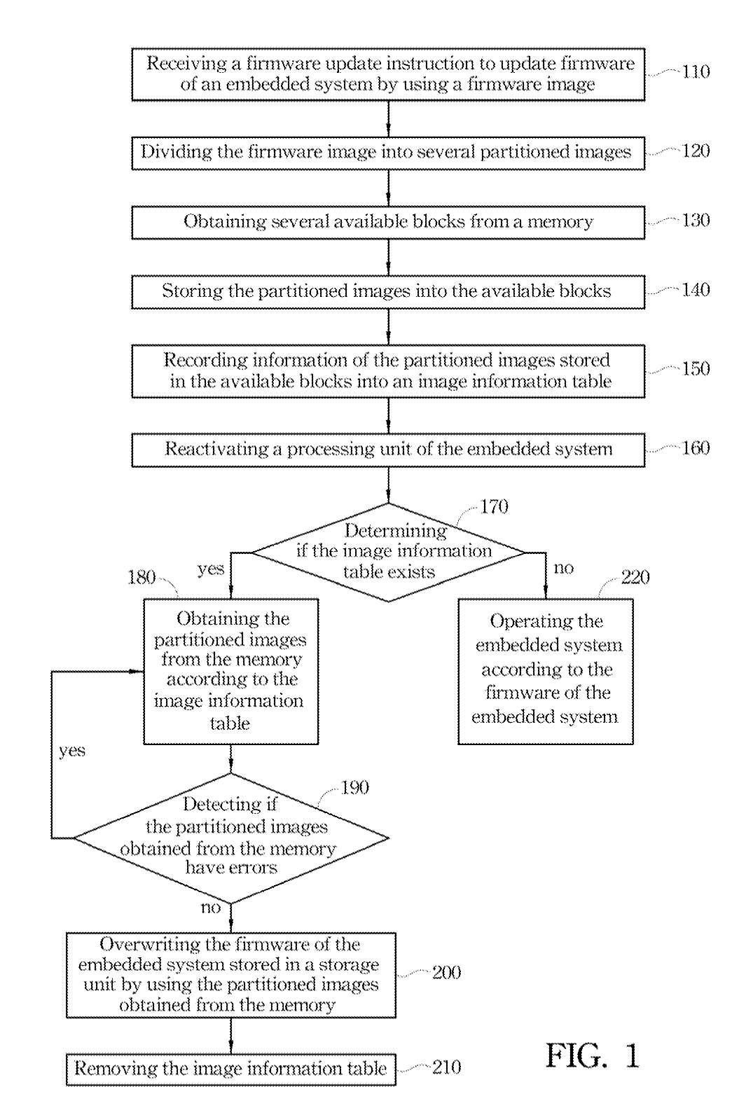

Referring to FIG. 1. FIG. 1 is a flow chart of a method for updating firmware of an embedded system according to one embodiment of the present invention. The method for updating the firmware of the embedded system divides an image (firmware image) for updating the firmware into several partition images, and to store several partition images into several available blocks obtained from a memory. Thereafter, the firmware of the embedded system is updated by using the partition images stored in the memory. The method for updating the firmware 100 includes the steps as follow.

In step 110, a firmware update instruction is received and updates the firmware of the embedded system by using a firmware image, wherein the embedded system includes a processing unit, a memory and a storage unit, and the firmware of the embedded system is stored in the storage unit. The memory can be the random access memory (RAM) or other memories which can be used as the main memory of an embedded system. The storage unit can be the flash memory, non-volatile random access memory (NVRAM) or other storage units which can be accessed. Furthermore, the firmware image can be included in the firmware update instruction, or the firmware update instruction can include information of the location at which the firmware image is stored for being accessed by the embedded system.

In step 120, the firmware image is divided into several image divides, wherein the several partition images can have the same file size (split file size). Therefore, the split file size can be obtained before step 120. Next, step 120 can be achieved by sequentially reading several data with the split file size from the firmware image as the partition images. In other words, one of the data with the split file size is asserted as one of the partition images after it is read from the firmware image, wherein the split file size can be modified by users. Moreover, the split file size which can be stored in available blocks of the memory can be calculated according to the size of each available block of the memory.

In step 130, several available blocks are obtained from the memory, wherein the number of the available blocks obtained from the memory is larger than or equal to the number of the partition images, and the size of each available block is larger than or equal to the size of the partition images. Thus, the available blocks obtained from the memory can be used to store the partition images.

In step 140, the partition images are stored into the available blocks.

In step 150, information of the partition images which is stored in the available blocks is recorded into an image information table, wherein the information of the partition images can include memory addresses of the available blocks in which the partition images are stored, the split file size of the partition images or other information related to the partition images.

To prevent the processing unit of the embedded system from lacking of sufficient system resource for updating the firmware after being operated for a period of time, in step 160, the processing unit of the embedded system is reactivated. Therefore, after the processing unit of the embedded system is reactivated, the system resource of the processing unit can be released and the processing unit has enough system resource to update the firmware. Moreover, that updating the firmware fails because the processing unit does not have enough system resource can be avoided.

Next, according to the image information table, the partition images are obtained from the memory (step 180), and the firmware of the embedded system, which is stored in the storage unit, is overwritten by using the partition images obtained (step 200), wherein before step 200, the storage unit can be set to be accessible for executing the overwriting of step 200. Furthermore, after step 200, the storage unit can be set to be write protected to prevent damage to the embedded system caused by a modification of the overwritten firmware. Therefore, the firmware of the embedded system still can be updated even though the memory of the embedded system does not have enough continuous available space.

Moreover, after step 150, the image information tale can be stored as the basis for updating the firmware after the embedded system has been reactivated (step 160). Thereafter, before step 180, the step of determining if the image information table exists can be performed (step 170). However, if the image information table does not exist, the embedded system is operated according to the firmware of the embedded system stored in the storage unit (step 220).

To prevent the firmware from being updated due to the existence of the image information table after the processing unit of the embedded system has been reactivated, thereby the image information table can be removed (step 210) after the firmware of the embedded system is overwritten (step 200). Therefore, it can be avoided to repeat to update the firmware.

Furthermore, the method for updating the firmware 100 supports debug function. Therefore, the method for updating the firmware 100 can include the step of detecting if the partition images obtained have errors (step 190), wherein step 190 can be achieved by using a checksum function or other debug methods. Next, if the partition images have no errors, the firmware of the embedded system, which is stored in the storage unit, is overwritten by using the partition images obtained (step 200). However, if the mage divides have errors, according to the image information table, the partition images are obtained again from the memory (step 180), wherein if that obtaining partition images without errors cannot be achieved, a remind signal can be produced to remind users that the partition images stored in the memory have errors.

According to the aforementioned embodiments of the present invention, the advantages of applying the embodiments of the present invention are as below. Even though the memory of the embedded system does not have enough continuous available space, the firmware of the embedded system still can be updated. Moreover, by reactivating the processing unit of the embedded system to release the system resource of the processing unit, that updating the firmware fails because the processing unit does not have enough system resource can be avoided. That is to say, even though the embedded system has been operated for a period of time, the embedded system still can update the firmware.

Although the present invention is disclosed with embodiments as above, it is not used to limit the present invention, and any one skilled in the art can make various changes and modifications without departing from the spirit and range of the present invention. Therefore, the contents of the present invention under protection depend on the following claims.

What is claimed is:

1. A method for updating firmware of an embedded system comprising:
receiving a firmware update instruction for updating the firmware of the embedded system by using a firmware image, wherein the embedded system comprises a memory and a storage unit, and the firmware of the embedded system is stored in the storage unit;
dividing the firmware image into a plurality of partitioned images;
obtaining a plurality of available blocks from the memory; storing the partitioned images into the available blocks;
recording information of the partitioned images stored in the available blocks into an image information table;
obtaining the partitioned images from the memory according to the image information table; and
overwriting the firmware of the embedded system by using the partitioned images obtained.

2. The method of claim 1, wherein the embedded system further comprises a processing unit, further comprising:
reactivating the processing unit before overwriting the firmware of the embedded system stored in the storage unit.

3. The method of claim 1, further comprising:
determining if the image information table exists;
obtaining the partitioned images from the memory according to the image information table when the image information table exists; and
operating the embedded system according to the firmware of the embedded system when the image information table does not exist.

4. The method of claim 1, further comprising:
obtaining a split file size of each of the partitioned images, wherein the partitioned images have the same size.

5. The method of claim 4, wherein the step of dividing the firmware image into the partitioned images comprises:
sequentially reading a plurality of sets of data at the split file size from the firmware image as the partitioned images.

6. The method of claim 1, further comprising:
removing the image information table after the step of overwriting the firmware of the embedded system stored in the storage unit by using the partitioned images obtained.

7. The method of claim 1, further comprising:
setting the storage unit to be accessible before the step of overwriting the firmware of the embedded system stored in the storage unit by using the partition images obtained.

8. The method of claim 1, further comprising: setting the storage unit to be write protected after the step of overwriting the firmware of the embedded system stored in the storage unit by using the partition images obtained.

9. The method of claim 1, further comprising:
detecting if the partitioned images obtained have errors, wherein when the partitioned images obtained have no errors, the step of overwriting the firmware of the embedded system stored in the storage unit by using the partition images obtained is achieved.

10. The method of claim 9, wherein the step of detecting if the partitioned images obtained have errors is achieved by using a checksum function.
